(19) United States
(12) Patent Application Publication
(10) Pub. No.: US 2002/0093573 A1
(43) Pub. Date: Jul. 18, 2002

(54) Digital camera for authenticating a digital visual image

(75) Inventors: Daryl Carvis Cromer, Apex, NC (US); Richard Alan Dayan, Wake Forest, NC (US); Howard Jeffrey Locker, Cary, NC (US); Andy Lloyd Trotter, Raleigh, NC (US); James Peter Ward, Raleigh, NC (US)

Correspondence Address: Andrew J. Dillon, FELSMAN, BRADLEY, VADEN, GUNTER & DILLON, LLP, Suite 350 Lakewood on the Park, 7600B North Capital of Texas Highway, Austin, TX, 78731, US

(73) Assignee: International Business Machines Corporation

(21) Appl. No.: 09/759,924

(22) Filed: Jan. 12, 2001

(51) Int. Cl. H04N 5/76

(52) U.S. Cl. 348/231

(57) ABSTRACT

A digital camera and method are disclosed for verifying that a particular digitized visual image was produced by the digital camera. A visual image is stored in a digital format in the camera. A digital signature is generated for the image utilizing the camera only in response to the storage of the image in the particular camera which captured the image. The digital signature associates the stored image with the camera. The digital signature is stored only in the camera separately from the image in the camera. The digital signature is capable of being utilized only within the camera which generated the signature. It is not accessible outside of the particular camera which generated the signature. The signature is inaccessible to devices other than the camera. Subsequently, a digital visual image may be authenticated as being produced by this digital camera utilizing the digital signature stored in the digital camera. Only this digital camera is capable of authenticating images which were produced by this camera. Images produced by other digital cameras will not be authenticated by this camera. A digital camera will authenticate only unaltered images which were originally captured by this particular digital camera.

### BACKGROUND OF THE INVENTION

1. Field of the Invention

The present invention relates in general to a digital camera and, in particular, to a digital camera for verifying that a particular digitalized visual image was produced by the digital camera. Still more particularly, the present invention relates to a digital camera for verifying that a particular digitalized visual image was produced by the digital camera utilizing a signature generated for the image where the signature is inaccessible to all devices other than the camera and where the signature is inaccessible outside of the camera.

2. Description of the Related Art

Digital cameras are known in the art. Digital cameras capture visual images, digitize the visual image, and store the digitized image within the camera in a digital format.

Many software applications exist which permit a user to alter the original, stored visual image. These applications permit a user to easily add or remove images within the original image. For example, it is very easy for a novice user to alter the original image such as by merging two visual images together to add a person who was not present at the time the original visual image was stored. Therefore, it is necessary to have a method and system for verifying that a particular visual image has not been altered since it was originally stored.

It is known in the art to verify a digital image utilizing a digital signature which is stored with the image. Both the signature and image are stored for later use. The signature and image are stored either within the digital camera or outside of the camera. In order to authenticate an image using this method after the image is stored outside of the camera, the signature must accompany the image. Therefore, the signature must always be readily available and accessible.

A problem exists with the method described above, however. Once the signature is made available outside of the camera, the signature itself is subject to being altered. A determined user could alter the original image in some manner, and then also alter the signature to make it appear that the image accompanying the signature is an original, unaltered image.

Other methods exist which embed information into the image itself. The original image is captured and then altered. Some of these methods alter the image by inserting the signature into the image. The altered image, including the embedded information such as an embedded signature, then is made available outside of the camera.

Therefore a need exists for a digital camera which is capable of authenticating images which were originally captured by the particular camera and which have not been altered from their originally captured form.

### SUMMARY OF THE INVENTION

A digital camera and method are disclosed for verifying that a particular digitized visual image was produced by the digital camera. A visual image is stored in a digital format in the camera. A digital signature is generated for the image utilizing the camera only in response to the storage of the image in the particular camera which captured the image. The digital signature associates the stored image with the camera. The digital signature is stored only in the camera separately from the image in the camera. The digital signature is capable of being utilized only within the camera which generated the signature. It is not accessible outside of the particular camera which generated the signature. The signature is inaccessible to devices other than the camera. Subsequently, a digital visual image may be authenticated as being produced by this digital camera utilizing the digital signature stored in the digital camera. Only this digital camera is capable of authenticating images which were produced by this camera. Images produced by other digital cameras will not be authenticated by this camera. A digital camera will authenticate only unaltered images which were originally captured by this particular digital camera.

The above as well as additional objectives, features, and advantages of the present invention will become apparent in the following detailed written description.

### BRIEF DESCRIPTION OF THE DRAWINGS

The novel features are set forth in the appended claims. The present invention itself, however, as well as a preferred mode of use, further objectives, and advantages thereof, will best be understood by reference to the following detailed description of a preferred embodiment when read in conjunction with the accompanying drawings, wherein:

FIG. 1 depicts a detailed pictorial representation of a digital camera in accordance with the method and system of the present invention;

FIG. 2 illustrates a block diagram of a digital camera including an embedded signature device in accordance with the method and system of the present invention;

FIG. 3 illustrates a high level flow chart which depicts establishing and storing a master key pair and a certificate in a signature device embedded in a digital camera in accordance with the method and system of the present invention;

FIG. 4 depicts a high level flow chart which illustrates capturing a visual image using a digital camera and creating a signature to verify whether or not the image has been altered in accordance with the method and system of the present invention;

FIG. 5 illustrates a high level flow chart which depicts the retrieval of a visual image stored in a digital camera to be authenticated in accordance with the method and system of the present invention; and

FIG. 6 depicts a high level flow chart which illustrates verifying whether or not a visual image captured by a digital camera has been altered in accordance with the method and system of the present invention.

### DETAILED DESCRIPTION OF A PREFERRED EMBODIMENT

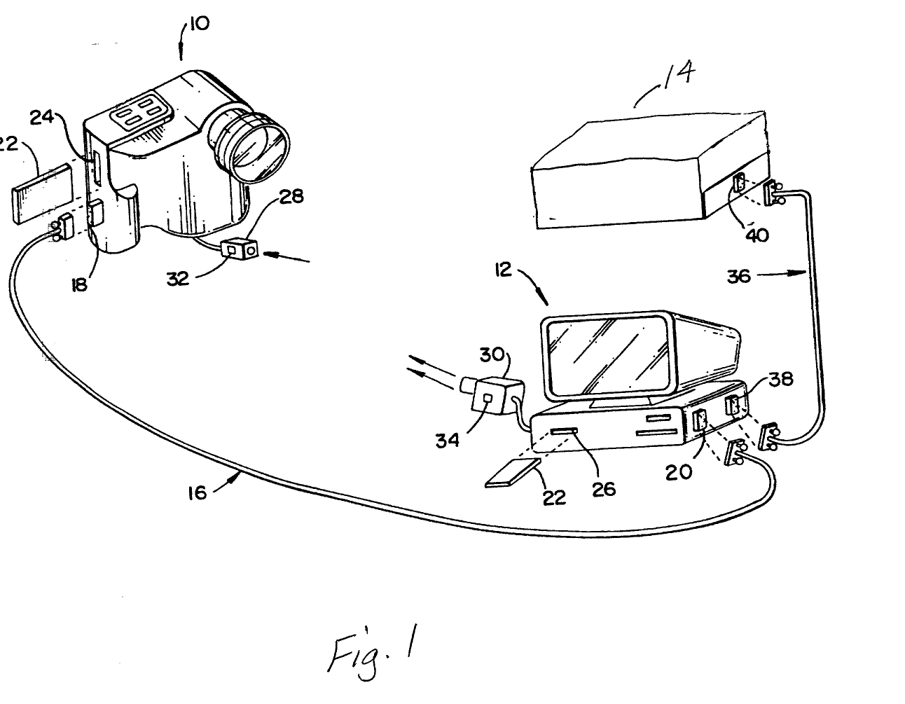

A preferred embodiment of the present invention and its advantages are better understood by referring to FIGS. 1-6 of the drawings, like numerals being used for like and corresponding parts of the accompanying drawings.

The present invention is a digital camera which is capable of authenticating images which were originally captured by this particular camera and which have not been altered from their originally captured form. A signature device is included in the digital camera. The signature device is used to generate a digital signature only in response to capturing and storing a visual image in digital form in the camera. The signature generated in response to capturing and storing a particular visual image associates the original visual image with the digital camera which produced the original image.

The signature and the digitized image are stored separately in the camera. The digitized image is not altered from its originally captured form, i.e. there are no signatures or other markings stored in or embedded in the image.

Once an image has been captured by the camera, it may be transmitted outside of the camera. An image may be verified as being unaltered and as being produced by a particular digital camera utilizing the present invention. If a user wishes to verify that a particular digitized image is unaltered and produced by a particular digital camera, the user must have access to the particular digital camera which originally captured the image. The present invention permits an image to be authenticated only by the camera which originally captured the image. Once the image is authenticated by the camera, the user may be assured that the particular camera captured the image, and that the image the user has in his/her possession has not been altered since it was originally captured.

Only the camera which originally captured the image will be able to authenticate that an image has not been altered. When the image is captured, the camera will generate a signature which is not transmitted outside of the camera and which is not accessible to devices outside of the camera. Because no other camera will have the signature generated for this image, no other camera will be able to authenticate the image produced by this camera.

The present invention describes a process whereby an image is first captured by a particular camera. The image is stored in a file within the camera. The image is hashed utilizing any well known hashing algorithm to produce a digest. The digest is then passed to the signature device which signs the digest to create a signature for this image. The signature is then stored in the camera, associated with this image using the filename where the image is stored. The signature is never transmitted outside of the camera, and cannot be accessed by devices outside of the camera.

Subsequently, when a user wishes to verify the a particular image is unaltered and was produced by a particular camera, the user must first obtain access to the camera believed to have captured the image. Using that camera, an image may be verified by first hashing the image supplied by the user to produce a first digest. The signature associated with this image is then located within the signature device and decrypted to produce a second digest. The first and second digests are then compared. If they match, the user can be assured that the image has not been altered and that this camera was used to capture the image. If the digests do not match, then the image supplied by the user was either not captured by this particular digital camera or it was captured by this camera but has been altered from its original form.

In this manner, an image is authenticated for use in situations such as evidence in court proceedings. For example, images of crime scenes may be authenticated using this invention.

FIG. 1 illustrates a pictorial representation of a digital camera including an embedded signature device in accordance with the method and system of the present invention. A digital camera 10 is depicted coupled to a computer system 12 and a peripheral device such as a printer 14. A variety of means of communication between camera 10 and computer system 12 are shown including a cable assembly 16 interconnecting the camera 10 and computer system 12 through connectors 18 and 20. Communication can also be accomplished through use of a card 22, such as a PCMCIA card for use with card/disk slots 24, 26. Radiated signals can also be used for communication as indicated by transceivers 28, 30. In addition, information can also be transferred through connections 32, 34 to a modem for transmission through a telephone system. Computer system 12 is shown interconnected with the printer 14 by way of cable assembly 36 and connectors 38, 40.

Camera 10 is utilized to capture and store a visual image. The original visual image is initially stored in camera 10. The original image may be transmitted from camera 10 to another device, such as computer system 12 and may be printed utilizing printer 14.

Once the original image leaves camera 10 it becomes increasingly easy to alter the original image. A user could easily alter a digital file containing an image utilizing computer system 12.

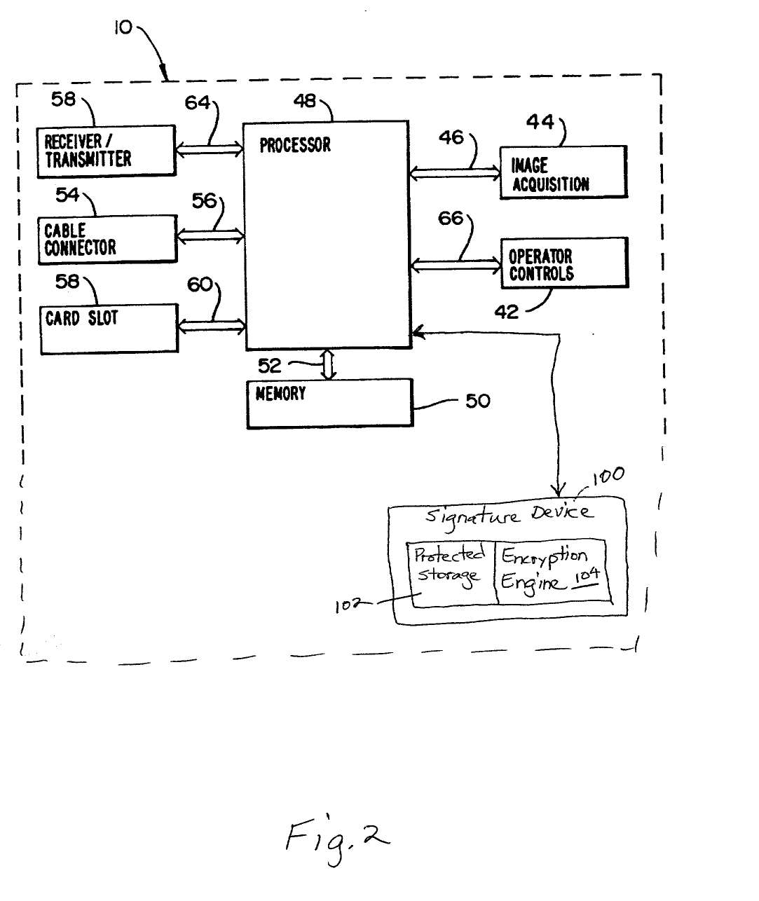

FIG. 2 depicts a more detailed pictorial representation of the digital camera of FIG. 1 in accordance with the method and system of the present invention. Digital camera 10 includes an image acquisition apparatus 44 in communication through bus 46 with a processor 48. The processor by way of bus 52, stores data in memory 50, which also includes ROM memory for basic operations. Input and output of data is through one of the various means described above, including cable connector 54 through bus 56, card/disk slot 58 through bus 60, transceiver 62 by way of bus 64, or modem connection. Controls 42 are shown connected to the processor by way of bus 66.

The image acquisition apparatus 44 includes components well known to those skilled in the art and need not be shown in detail in order to practice the invention. The acquisition apparatus 44 includes an image optical pickup, such as a charged coupled device (CCD) and A/D circuitry to convert the analog CCD signals to digital form for processor 48.

In accordance with an important feature of the present invention, camera 10 includes a signature device 100. At the time camera 10 is manufactured, a master key pair may be stored in camera 10 in protected storage 102 and signature device 100. The master key pair includes a master public key and a master private key. Only the master private key needs to be stored in storage 102. The master public key may or may not be stored there.

A certificate is also stored in storage 102 during manufacture of camera 10. The certificate will include a certificate public key.

Signature device 100 includes protected storage 102 and an encryption/decryption engine 104. Encryption/decryption engine 104 includes an encryption/decryption algorithm which is utilized to encode and decode messages transmitted and received by camera 10, and protected storage 102. Engine 104 can preferably perform public/private key encryption. Engine 104 may access a protected storage device 102. Protected storage device 102 is accessible only through engine 104, and is a one-time writable device. Storage device 104 cannot be read or written to by the other components of camera 10. Storage 102 is inaccessible to devices outside of camera 10. Therefore, once data is stored in storage 102, the components of camera 10 other than signature device 100 and devices outside of camera 10 may not access data stored in storage 102.

Signature device 100 may be implemented utilizing an electronically erasable storage device, such as an EEPROM. Access may be gained to storage 102 in order to initially store the camera's master key pair. However, after the master key pair is stored, it cannot be read outside of device 100.

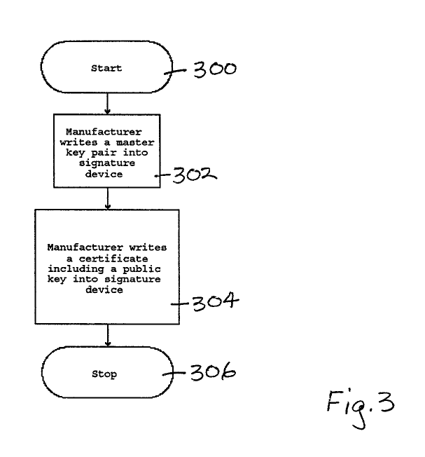

FIG. 3 illustrates a high level flow chart which depicts establishing and storing a master key pair and a certificate in signature device 100 embedded in digital camera 10 in accordance with the method and system of the present invention. The process starts as depicted at block 300 and thereafter passes to block 302 which illustrates a manufacturer of digital camera 10 writing a master key pair, including a master public key and a master private key, into signature device 100. Thereafter, block 304 depicts the manufacturer of digital camera 10 writing a certificate which includes a certificate public key into signature device 100. The process then terminates as illustrated by block 306.

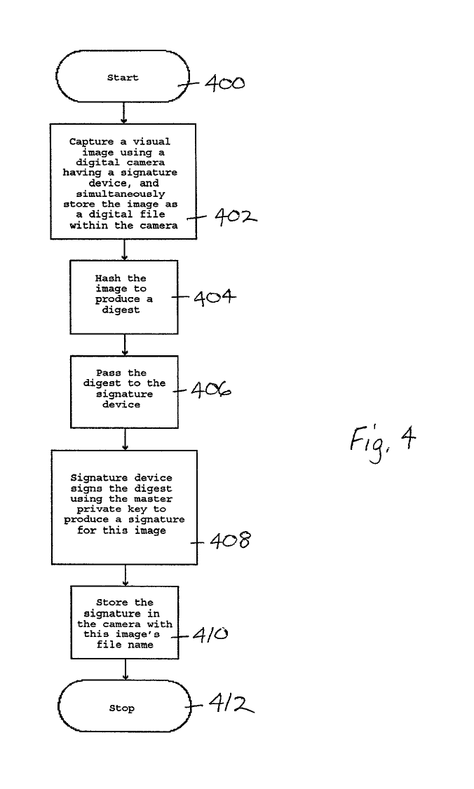

FIG. 4 depicts a high level flow chart which illustrates capturing a visual image using a digital camera and creating a signature to verify whether or not the image has been altered in accordance with the method and system of the present invention. The process of FIG. 4 is executed within digital camera 10 by processor 48 in conjunction with the other internal components of camera 10.

The process starts as depicted at block 400 and thereafter passes to block 402 which illustrates digital camera 10 capturing a visual image and simultaneously storing the visual image as a digital file in camera 10. The image file will be stored with a filename which identifies the image preferably in memory 50. Next, block 404 depicts processor 48 hashing the digital image to produce a digest. The digest is then passed, as illustrated by block 406, to signature device 100. Thereafter, block 408 depicts signature device 100 signing the digest using the master private key to produce a signature for the digital image used to produce the digest. Therefore, this digital image is associated with this signature. Block 410 illustrates storing the signature for this image in protected storage 102 with the image's file name. The process then terminates as depicted by block 412.

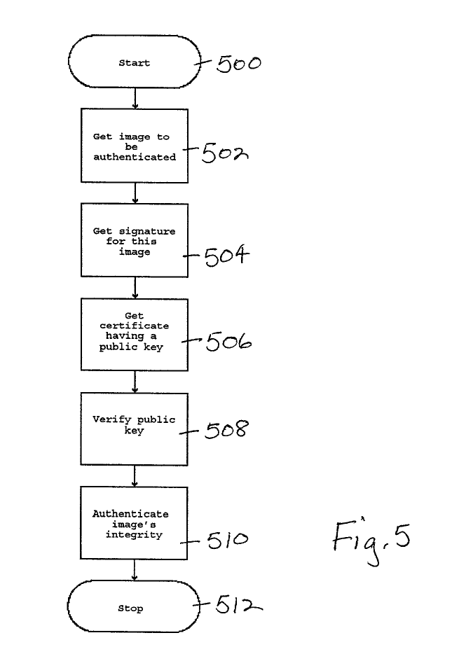

FIG. 5 illustrates a high level flow chart which depicts the retrieval of a visual image stored in a digital camera to be authenticated in accordance with the method and system of the present invention. The process of FIG. 5 is executed within camera 10.

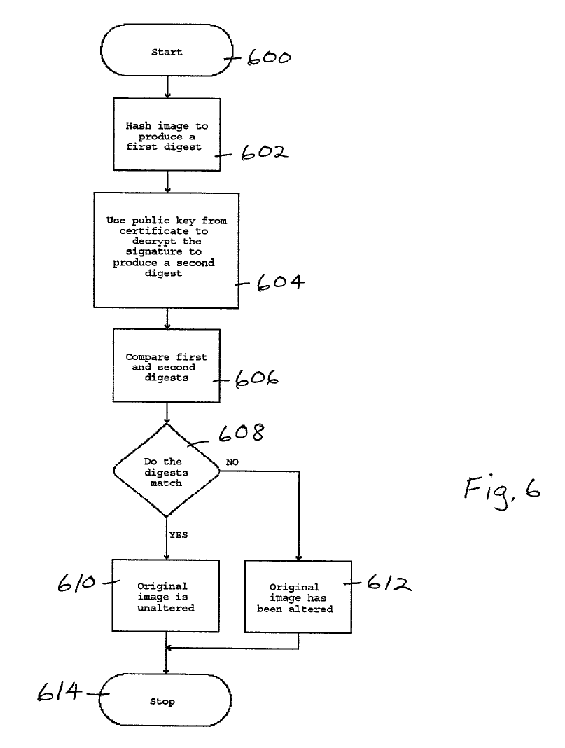

The process starts as depicted at block 500 and thereafter passes to block 502 which illustrates getting an image to authenticate. Next, block 504 depicts camera 10 getting the signature which was created for this image using the filename of this image. Block 506, then, illustrates getting the certificate, stored in memory 50 in the camera, having a public key. The process then passes to block 508 which depicts verifying the public key stored in the certificate. Next, block 510 illustrates verifying the image's integrity. FIG. 6 illustrates the process of verifying the image's integrity in greater detail. The process then terminates as depicted by block 512.

FIG. 6 depicts a high level flow chart which illustrates verifying whether or not a visual image captured by a digital camera has been altered in accordance with the method and system of the present invention. The process starts as depicted by block 600 and thereafter passes to block 602 which illustrates hashing an image to produce a first digest. Next, block 604 depicts using the public key obtained from the certificate to decrypt the signature associated with this image to produce a second digest. Thereafter, block 606 illustrates comparing the first digest to the second digest. Block 608 depicts a determination of whether or not the digests are the same. If a determination is made that the digests match, the process passes to block 610 which illustrates a determination that the original image has not been altered since it was originally captured by camera and that the image was originally captured by this camera. The process then terminates as depicted by block 614.

Referring again to block 608, if a determination is made that the digests do not match, the process passes to block 612 which illustrates a determination that the original image has been altered since it was originally captured by camera. The process then terminates as depicted by block 614.

While a preferred embodiment has been particularly shown and described, it will be understood by those skilled in the art that various changes in form and detail may be made therein without departing from the spirit and scope of the present invention.

What is claimed is:

1. A method in a digital camera for verifying that a particular digital visual image was produced by said digital camera, said method comprising the steps of:
storing a visual image in a digital format in said camera;
generating a digital signature for said image utilizing said camera only in response to said storage of said image in said camera, said digital signature associating said stored image with said camera;
storing said digital signature only in said camera, said signature being stored separately from said image in said camera, said digital signature capable of being utilized only within said camera by only said camera, wherein said signature is inaccessible to devices other than said camera; and
subsequently authenticating said particular digital visual image as being produced by said digital camera utilizing said digital signature stored in said digital camera, wherein only said digital camera is capable of authenticating said particular digital visual image.

2. The method according to claim 1, further comprising the steps of:
storing said visual image in a file within said camera, said file being designated by a filename; and
storing said signature in said camera with said filename.

3. The method according to claim 1, further comprising the steps of:
establishing a hardware master key pair for said digital camera, said hardware master key pair including a master private key and a master public key, said hardware master key pair being associated with said digital camera so that said master private key is known to only said digital camera;
establishing a signature device having an encryption engine and a protected storage device, said protected storage device being accessible only through said encryption engine; and
storing said hardware master key pair in said protected storage device.

4. The method according to claim 3, wherein said step of generating a digital signature further comprises the steps of:
hashing said stored image to produce an original image digest;
signing said first digest utilizing said master private key; and
storing said signed original image digest as said signature.

5. The method according to claim 4, wherein said step of authenticating said visual image further comprises the steps of:
retrieving an image to authenticate;
retrieving a signature for said image which is to be authenticated;
hashing said image which is to be authenticated to produce a first digest;
decrypting said retrieved signature to retrieve a second digest;
comparing said first digest to said second digest;
determining that said image has been altered in response to a determination that said first and second digests do not match; and
determining that said image has not been altered in response to a determination that said first and second digests match.

6. The method according to claim 1, wherein said step of generating a digital signature further comprises the steps of:
hashing said stored image to produce an original image digest;
signing said first digest utilizing a master private key; and
storing said signed original image digest as said signature.

7. The method according to claim 6, wherein said step of authenticating said visual image further comprises the steps of:
retrieving an image to authenticate;
retrieving a signature for said image which is to be authenticated;
hashing said image which is to be authenticated to produce a first digest;
decrypting said retrieved signature to retrieve a second digest;
comparing said first digest to said second digest;
determining that said image has been altered in response to a determination that said first and second digests do not match; and
determining that said image has not been altered in response to a determination that said first and second digests match.

8. A digital camera for verifying that a particular digital visual image was produced by said digital camera, comprising:
memory means for storing a visual image in a digital format in said camera;
a signature device for generating a digital signature for said image utilizing said camera only in response to said storage of said image in said camera, said digital signature associating said stored image with said camera;
memory means for storing said digital signature only in said camera, said signature being stored separately from said image in said camera, said digital signature capable of being utilized only within said camera by only said camera, wherein said signature is inaccessible to devices other than said camera; and
means for subsequently authenticating said particular digital visual image as being produced by said digital camera utilizing said digital signature stored in said digital camera, wherein only said digital camera is capable of authenticating said particular digital visual image.

9. The digital camera according to claim 8, further comprising:
said memory means for storing said visual image in a file within said camera, said file being designated by a filename; and
said memory means for storing said signature in said camera with said filename.

10. The digital camera according to claim 8, further comprising:
said signature device including stored within it a hardware master key pair for said digital camera, said hardware master key pair including a master private key and a master public key, said hardware master key pair being associated with said digital camera so that said master private key is known to only said digital camera; and
said signature device having an encryption engine and a protected storage device, said protected storage device being accessible only through said encryption engine.

11. The digital camera according to claim 10, further comprising:
means for hashing said stored image to produce an original image digest;
means for signing said first digest utilizing said master private key; and
means for storing said signed original image digest as said signature.

12. The digital camera according to claim 11, further comprising:
means for retrieving an image to authenticate;
means for retrieving a signature for said image which is to be authenticated;
means for hashing said image which is to be authenticated to produce a first digest;
means for decrypting said retrieved signature to retrieve a second digest;
means for comparing said first digest to said second digest;
means for determining that said image has been altered in response to a determination that said first and second digests do not match; and
means for determining that said image has not been altered in response to a determination that said first and second digests match.

13. The digital camera according to claim 8, further comprising:
means for hashing said stored image to produce an original image digest;
means for signing said first digest utilizing a master private key; and
means for storing said signed original image digest as said signature.

14. The digital camera according to claim 13, further comprising:
means for retrieving an image to authenticate;
means for retrieving a signature for said image which is to be authenticated;
means for hashing said image which is to be authenticated to produce a first digest;
means for decrypting said retrieved signature to retrieve a second digest;
means for comparing said first digest to said second digest;
means for determining that said image has been altered in response to a determination that said first and second digests do not match; and
means for determining that said image has not been altered in response to a determination that said first and second digests match.
